(19) United States
(12) Patent Application Publication
(10) Pub. No.: US 2012/0098633 A1
(43) Pub. Date: Apr. 26, 2012

(54) Transformer

(75) Inventors: Manfred Schlenk, Augsburg (DE); Hans Hoffmann, Augsburg (DE); Mykhaylo Raykhman, Munchen (DE); Jorg Oehmen, Riemerling (DE)

(73) Assignee: MINEBEA CO., LTD., Nagano-ken (JP)

(21) Appl. No.: 13/280,001

(22) Filed: Oct. 24, 2011

(30) Foreign Application Priority Data
Oct. 26, 2010 (DE) 10 2010 049 668.5

(51) Int. Cl. H01F 27/28

(52) U.S. Cl. 336/170

(57) ABSTRACT

A transformer (1) for balancing the current in several channels, having a primary winding (Wp) and at least two secondary windings (Ws). The transformer (1) has a plurality of closed transformer cores (2) on each of which a secondary winding (Ws) is disposed. The primary winding (Wp) encloses all transformer cores (2). The primary and the secondary windings are preferably disposed opposite each other on the transformer core (2). Current balancing is effected through changes in flux in the secondary windings (Ws) and a primary flux response.

### CROSS-REFERENCE TO RELATED APPLICATIONS

This application claims the benefit of German Patent Application No. 102010049668.5, filed Oct. 26, 2010, which is incorporated herein by reference as if fully set forth.

### BACKGROUND

The invention relates to a transformer having one primary winding and at least two secondary windings, used particularly for balancing currents in parallel channels of an electronic circuit.

Backlights for flat-screen televisions generally have cold cathode tubes or light emitting diode strings that are arranged in parallel and each connected to a control circuit in a channel. To ensure that all screens are uniformly illuminated, all lamps must have the same brightness, which basically means that the flow of current has to be the same. Owing to series-production tolerances of the components, for the same voltage, the current is not necessarily the same. Current balancing is thus required.

This can be realized, for example, using a current balancing network having transformers. Here, a transformer is disposed in each channel, the primary winding being connected to the lamp and all secondary windings being connected electrically in series, so that the same current occurs on the secondary side in all secondary windings. As a result, the current on the primary side will also be the same in all channels. To achieve this, however, a large number of transformers are needed.

### SUMMARY

The object of the invention is to create an arrangement for balancing currents that has a simpler construction and requires fewer components.

This object has been achieved by a transformer in which each secondary winding is disposed on its own closed transformer core and the primary winding encloses all transformer cores.

The transformer has a secondary winding for each channel whose current is to be balanced. The current in a channel that flows through the secondary winding induces a change in the magnetic flux in this transformer core. The change in flux elicits a primary flux response, which in turn induces a change in flux, and thus current, in the other secondary windings. This continues until the same flux, and thus the same current, occurs in all secondary windings. In contrast to the prior art, balancing does not take place via electric currents in the secondary branch, but rather via magnetic flux.

It is advantageous if the transformer cores are made substantially rectangular and if the primary winding and the secondary windings are disposed on opposing limbs of the core. The transformer cores are preferably disposed parallel to each other.

In a preferred embodiment, the transformer has a trough to receive the cores as well as the windings, and the secondary windings are each disposed about an opening through which the core limb passes and the primary winding is disposed about all such openings.

### BRIEF DESCRIPTION OF THE DRAWINGS

The invention is described in more detail below with reference to the enclosed drawings.

The drawings show:

FIG. 1 is a schematic view of a transformer according to the invention having N cores, N secondary windings and a common primary winding,

FIG. 2 is a perspective view of a preferred embodiment of a transformer according to the invention having four cores, four secondary windings and one common primary winding, and

FIG. 3 is a view showing the same embodiment according to FIG. 2 with all cores mounted.

### DETAILED DESCRIPTION OF THE PREFERRED EMBODIMENTS

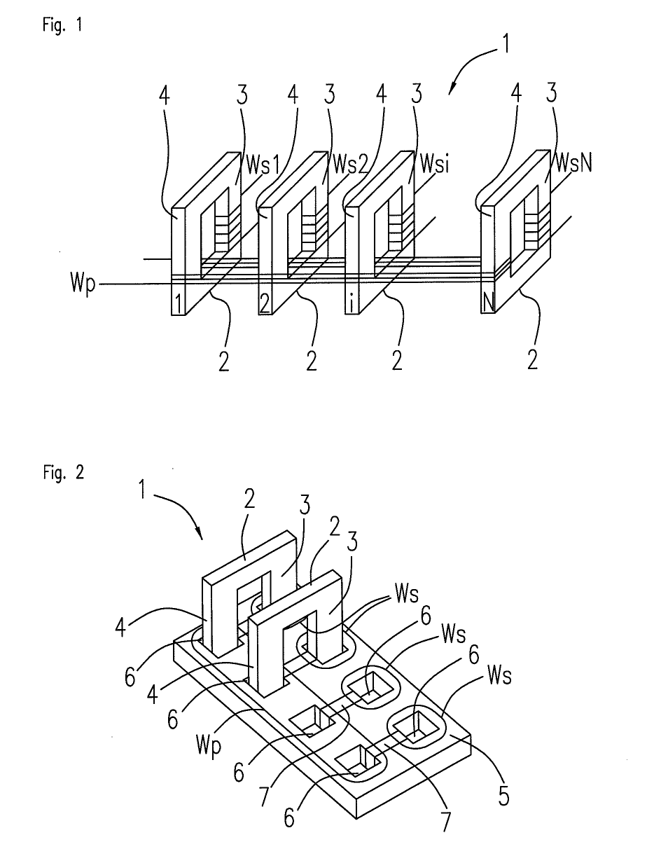

In FIG. 1 a transformer according to the invention is shown schematically. To balance n channels, the transformer 1 has a total of N transformer cores 2 and N secondary windings Ws1, Ws2, . . . , WsN.

The transformer cores 2 are substantially rectangular in shape and closed. The secondary windings Ws are each disposed on a limb 3 of a transformer core 2. A primary winding Wp is wound about all transformer cores 2, the primary winding Wp being disposed, for example, on the limb 4 of the core 2 lying opposite the secondary winding Ws.

In the Figures, the transformer cores 2 are disposed with their flat sides parallel to each other. This arrangement is arbitrary and non-restrictive. The cores 2 could, for example, also be arranged in a circle. The transformer cores 2 could, for example, equally be made circular, the primary and secondary winding once again being preferably disposed on the core 2 opposite one another.

The invention is based on the fact that the primary flux Φpi changes when a change in the flux Φsi in a secondary winding Wsi occurs, wherein i=1, . . . , N. Such a change may occur, for example, through a lower or higher current flow in the secondary winding Wsi. Since the N secondary windings Ws are on different cores 2, the primary flux response is only Φpi=Φsi/N.

By way of example, it is assumed that in channel i a current Ii flows that is larger, for example, than the currents in the other channels. The current Ii generates a secondary flux Φsi. As described above, the primary flux response is then Φpi=Φsi/N in branch circuit i. The overall flux Φi in channel i thus falls while in the other channels it increases to Φsi/N.

The voltage of winding Wsi thereby drops, while in the other channels it increases. The current Ii in channel i thereupon falls, while in the other channels it increases. This is repeated until the currents in all channels are the same.

In this way, the current in several channels can be balanced. According to the invention, only one transformer having a simple construction is needed for this purpose.

FIG. 2 shows an advantageous embodiment of a transformer according to the invention 1 having four transformer cores 2 (only two being illustrated). The cores 2 in the example are rectangular or square in shape. Moreover, the transformer 1 has a trough 5 that is made, for example, out of plastic. The trough 5 has two openings 6 for each transformer core 2, one limb 3, 4 of a transformer core 2 passing through each opening. In the example, the cores 2 are made up of a U-section and an I-section 7, the joint lying within the openings 6 in the trough 5. Alternatively, the cores may also be made up of two identical U-shaped halves or other core sections.

To receive the windings, the trough 5 may have, for example, recesses into which the prefabricated windings can be simply inserted. The recesses to receive a secondary winding Ws are disposed on one side of the trough 5 each about an opening 6. On the other side of the trough 5 there is a recess to receive the primary winding Wp that passes around all the openings 6 on this side.

The plastic trough 5 allows the transformer 1 to be manufactured in a simple, mechanized process, thus ensuring low-cost production. The cores 2, made up, for instance, of a U-core and separate I-core 7 and disposed, for example, on an electrically insulating coil form, are inserted in the prefabricated primary winding Wp and secondary windings Ws.

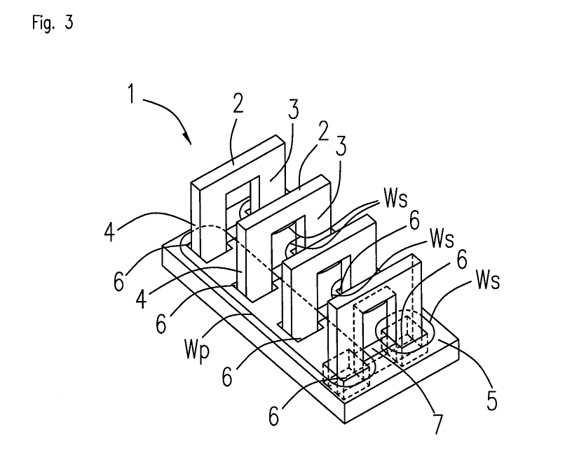

FIG. 3 shows the same embodiment as in FIG. 2 of a transformer according to the invention 1 having four mounted transformer cores 2.

### IDENTIFICATION REFERENCE LIST

1 Transformer
2 Transformer core
3 Limb (secondary side)
4 Limb (primary side)
5 Trough
6 Openings
7 I-core
Wp Primary winding
Ws Secondary winding
i Channel
n Number of channels

1. A transformer comprising one primary winding (Wp) and at least two secondary windings (Ws), each of the secondary windings (Ws) is disposed on a respective separate closed transformer core (2) and the primary winding (Wp) encloses all of the transformer cores (2).

2. The transformer according to claim 1, wherein the transformer cores (2) are substantially rectangular in shape and the primary winding (Wp) and the secondary windings (Ws) are disposed on opposing limbs (3, 4) of the core (2).

3. The transformer according to claim 1, wherein the transformer (1) has a trough (5) for receiving the windings (Wp, Ws) and the secondary windings (Ws) are each disposed about an opening (6) through which a core limb (4) passes and the primary winding is disposed about all of said openings (6).

4. The transformer according to claim 1, wherein the transformer cores (2) have flat sides and are disposed with the flat sides parallel to each other.
